(19) United States
(12) Patent Application Publication
(10) Pub. No.: US 2002/0087432 A1
(43) Pub. Date: Jul. 4, 2002

(54) Product configurator method and system

(76) Inventor: Ivette Muniz, Newtown, CT (US)

Correspondence Address: Daniel F. Perez, Bickel & Brewer, 4800 Bank One Center, 1717 Main Street, DALLAS, TX, 75201, US

(21) Appl. No.: 09/751,245

(22) Filed: Dec. 29, 2000

(51) Int. Cl. G06F 17/60

(52) U.S. Cl. 705/27

(57) ABSTRACT

A method and system in a remote computer network (80) for interactively identifying and promoting particular products via a web-based porta (290)I. User-provided information is initially compiled (406) and filtered (410) utilizing a set of predetermined product criteria (408) associated with particular product information. Filtered user-provided information is then generated (412) and the particular product information is configured (414) to match the filtered user-provided information, thereby enabling a web-based portal operator to interactively identify and promote the particular product information based on the compiled user-provided information. The user-provided information is compiled from an electronic query requiring user input. The remote computer network (80) has at least one client (92) connectable to one or more servers (88).

### FIELD OF THE INVENTION

The present invention is generally related to remote computer networks. The present invention is also related to methods and systems that utilize remote computer networks to interact with and assist potential electronic commerce users and customers. In particular, the present invention relates to web-based portals for delivering financial and business information to small business customers.

### BACKGROUND OF THE INVENTION

The development of computerized information resources, such as the Internet, and the proliferation of web browsers, permit users of data-processing systems to link to other servers and networks, and thus retrieve vast amounts of electronic information heretofore unavailable in an electronic medium. Such electronic information is increasingly displacing more conventional means of information transmission, such as newspapers, magazines, and even television. As a result of this displacement, commercial enterprises and endeavors previously practiced only by conventional means of information transmission, are now being implemented and practiced via the Internet and web browsers.

The term “Internet” is an abbreviation of “Internetwork,” and refers to the collection of networks and gateways that utilize the TCP/IP suite of protocols, which are well known in the art of computer networking. TCP/IP is an acronym for “Transport Control Protocol/interface Program,” a software protocol originally developed by the Department of Defense for communication between computers, but now primarily utilized as one of a number of standardized Internet communications protocols.

In the last decade of the 20th century, explosive growth occurred in the use of the globally-linked network of computers now known as the “Internet.” In particular, the World Wide Web, or simply the “web,” which facilitates the use of the Internet, has resulted in a revolution of electronic commerce and information transmission. The World Wide Web, well known in the Internet and computer networking arts, is composed of many pages or files of information distributed across a variety of computer servers and systems.

In order to utilize the World Wide Web, a client computer system runs a portion of software known as a graphical web browser, such as Netscape Navigator or Internet Explorer. “Netscape” and “Navigator” are trademarks of the Netscape Communications Corporation, while “Internet Explorer” is a trademark of Microsoft. The client computer system interacts with the browser to select a particular Uniform Resource Locator (URL), by which each page is identified. The URL denotes both the server machine, and the particular file or page on that machine. Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page is then displayed to the user on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical browser as well as formatting commands which “tell” the browser how to display the data. Thus, a typical web page includes text together with embedded formatting commands, referred to as “tags,” which can be utilized to control the font size, the font style (e.g., italic or bold), textual layout, and so forth. A web browser “parses” the HTML script in order to display the text in accordance with the specified format. HTML tags are also utilized to indicate how graphics, audio, and video are manifested to the user via the client's browser.

The majority of web pages also contain one or more references to other web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page is retrieved and replaces the currently displayed page.

Commercial enterprises, organizations, and companies are actively utilizing the World Wide Web to initiate commerce. Several phases of electronic commerce via the World Wide Web have taken place. The first phase, namely publicity for companies and organizations, has already occurred. Homepages are commonplace, an essential ingredient for any company which wishes to maintain itself in line with current business practices. The publicity material posted electronically on company homepages contain marketing information, product brands, and in some cases, product catalogues.

The second phase, namely to conduct commerce, is emerging. Enterprises are poised to conduct business utilizing the World Wide Web. They are seeking to make sales of their products and services through the World Wide Web. Software infrastructure is coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

Thus, many suppliers have begun to sell their goods and services over the World Wide Web by placing their catalogues on their web pages. Such online catalogues list content-related information (e.g., product description, price, availability, and so forth) describing various goods and services offered for sale.

They also list their business policies concerning, for example, cancellation policies.

The third phase of commercial World Wide Web development, namely, the business-to-business arena, is only now being seriously implemented. Web business-to-business solutions require two components. First, a customer must be willing to engage in commercial transactions through the World Wide Web. Second, the company or enterprise expecting customer participation must offer and implement a secure and efficient electronic information delivery system.

To date, such web-based business-to-business solutions have been mediocre at best, simply because the number of customers willing to participate in such solutions have been limited. While large corporations and commercial enterprises are increasingly willing to engage in web-based business-to-business solutions, small businesses have been reluctant to follow the lead of the larger companies. A need thus exists for a web-based business-to-business solution aimed at attracting small businesses to the new electronic commerce environment.

A lack of financial, marketing and business development information for small businesses has prevented small enterprises from effectively engaging in electronic commerce. Most web-based portals in existence today directed at entrepreneurs and small business typically are implemented in the form of a series of on-line brochures or catalogues. While adequate at providing basic business and financial information, such portals fail to satisfy customer preferences for marketing, lead generation, product sales and services to small business owners over the entire customer life cycle. Such portals also tend to be static. That is, information is not tailored to the needs and requirements of the customer.

Those skilled in the Internet and computer networking arts can thus appreciate, based on the foregoing, that what is needed to attract small businesses to the electronic commercial environment is a web-based portal that targets the needs of small businesses. Such a portal, if implemented properly, could provide valuable financial, marketing, and business development information to small business, while attracting increasing numbers of small businesses to the electronic commerce environment. It is believed that the small business web-based portal method and system described herein meets this increasingly important need.

### BRIEF SUMMARY OF THE INVENTION

It is one aspect of the present invention to provide an interactive web-based portal for a remote computer network.

It is another aspect of the present invention to provide a method and system in which user-tailored information is interactively rendered for a user based on user-provided information.

It is still another aspect of the present invention to provide a method and system in which user-tailored information is interactively rendered for a user based on user-provided information compiled via an electronic template.

It is yet another aspect of the present invention to provide a web-based portal for interactively delivering financial and business information to small business customers.

It is still another aspect of the present invention to provide a method and system for implementing a Product Configurator via a web-based portal.

The above and other aspects of the present invention are achieved as is now described. A method and system in a remote computer network for interactively identifying and promoting particular products via a web-based portal is described herein. User-provided information is initially compiled and filtered utilizing a set of predetermined product criteria associated with particular product information. Filtered user-provided information is then generated and the particular product information is configured to match the filtered user-provided information, thereby enabling a web-based portal operator to interactively identify and promote the particular product information based on the compiled user provided information. The user-provided information is compiled from an electronic query requiring user input. The remote computer network has at least one client connectable to one or more servers.

### BRIEF DESCRIPTION OF THE DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented;

FIG. 6 depicts a high-level flow chart of operations illustrative of a method for implementing Pre-Qualifying Templates, in accordance with a preferred embodiment of the present invention;

FIG. 7 illustrates a high-level flow chart of operations illustrative of a method for implementing Sales Process Drill-Down, in accordance with a preferred embodiment of the present invention;

FIG. 8 depicts a high-level flow chart of operations illustrative of a method for implementing a Product Configurator, in accordance with a preferred embodiment of the present invention;

FIG. 9 illustrates a high-level flow chart of operations illustrative of a method for implementing an Online Application, in accordance with a preferred embodiment of the present invention;

FIG. 10 depicts a high-level flow chart of operations illustrative of a method for implementing a Brochureware application, in accordance with a preferred embodiment of the present invention;

FIG. 11 illustrates a high-level flow chart of operations illustrative of a method for implementing other web-based portal or site areas, in accordance with a preferred embodiment of the present invention;

FIG. 12 depicts a table summarizing functional components utilized in accordance with a preferred embodiment of the present invention;

FIG. 13 illustrates a table summarizing additional functional components utilized in accordance with a preferred embodiment of the present invention;

FIG. 14 depicts a table summarizing additional functional components utilized in accordance with a preferred embodiment of the present invention;

FIG. 15 illustrates a table summarizing products, solutions, tools and education and transactional information that may be accessed via the method and system described herein, in accordance with a preferred embodiment of the present invention;

FIG. 16 depicts a small business web-based portal homepage displayed within a web browser graphical user interface window, in accordance with a preferred embodiment of the present invention;

FIG. 17 illustrates a flow chart of operations illustrating a Product Configurator method, in accordance with a preferred embodiment of the present invention; and

FIG. 18 depicts a high-level block diagram illustrating a Product Configurator system, in accordance with a preferred embodiment of the present invention.

### DESCRIPTION OF PREFERRED EMBODIMENTS

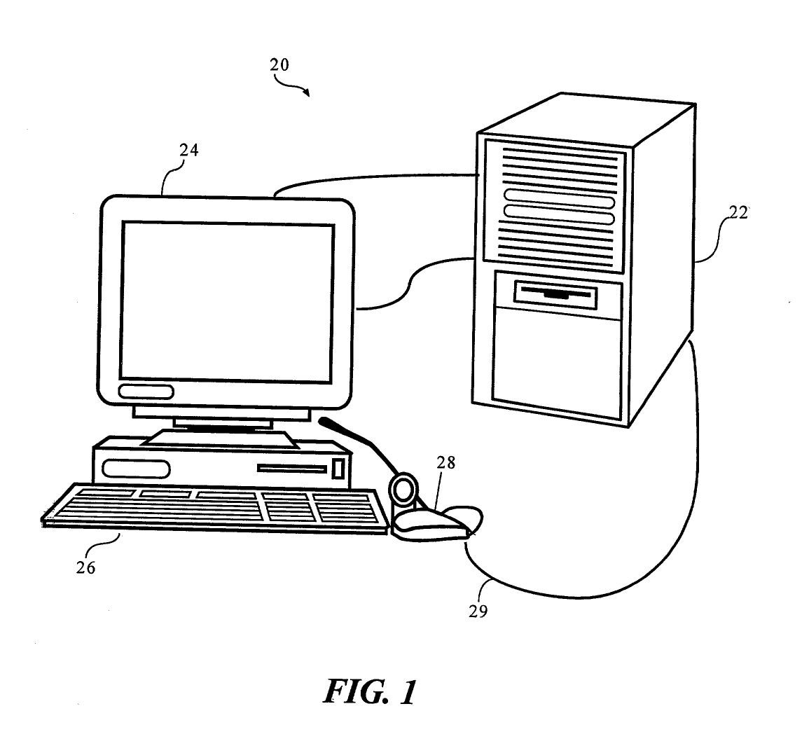

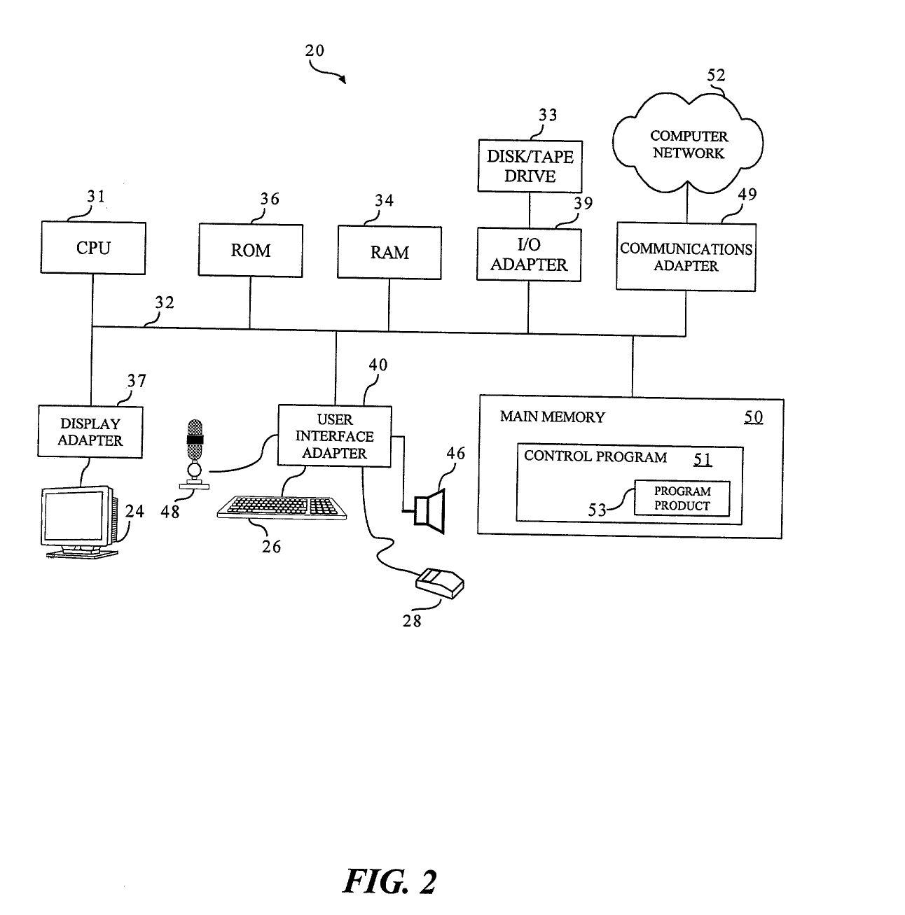

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is a complicated multi-user computing apparatus or a single-user workstation. In FIG. 1 and FIG. 2, like parts are identified by like numbers.

FIG. 2 depicts a representative hardware environment of a computer system in which a preferred embodiment of the present invention can be implemented. Computer system 20 includes a Central Processing Unit (“CPU”) 31, such as a conventional microprocessor, and a number of other units interconnected via system bus 32. Components and units of computer system can be implemented in a system unit, such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 is the visual output of computer system 20. Video display terminal 24 can be implemented as a CRT-based video display well known in the art of computer hardware. In a portable or notebook-based computer, however video display terminal 24 can be replaced with a gas plasma-based or LCD-based flat-panel display. Computer system 20 further includes user interface adapter 40 for connecting keyboard 26, mouse 28, speaker 46, microphone 48, and/or other user interface devices, such as a touch-screen device (not shown), to system bus 32. Communications adapter 49 connects computer system 20 to a computer network 52. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in the logic flow diagrams described herein. Control program 51 can be implemented as a computer program product 53, which can also be referred to simply as a program product.

It is important to note that, while the present invention has been (and will continue to be) described in the context of a fully functional computer system, those skilled in the art can appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module is typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation is private in that it is only accessible by the module. The implementation also contains source code that actually implements the routines in the module. Thus, a program product can be formed from a series of interconnected modules or instruction modules dedicated to working together to accomplish a particular task.

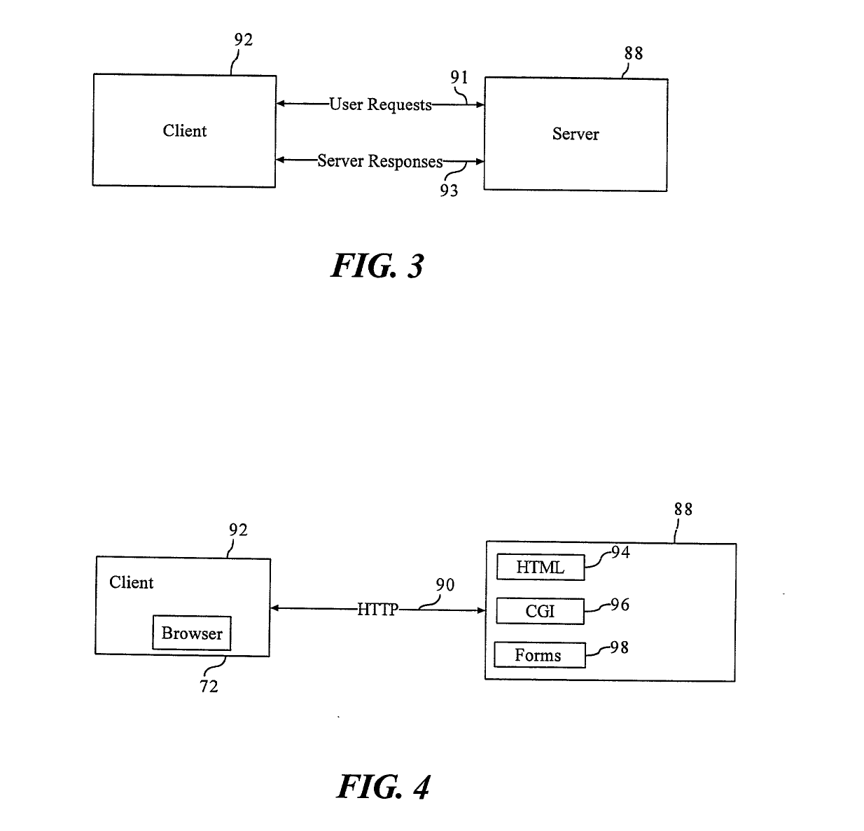

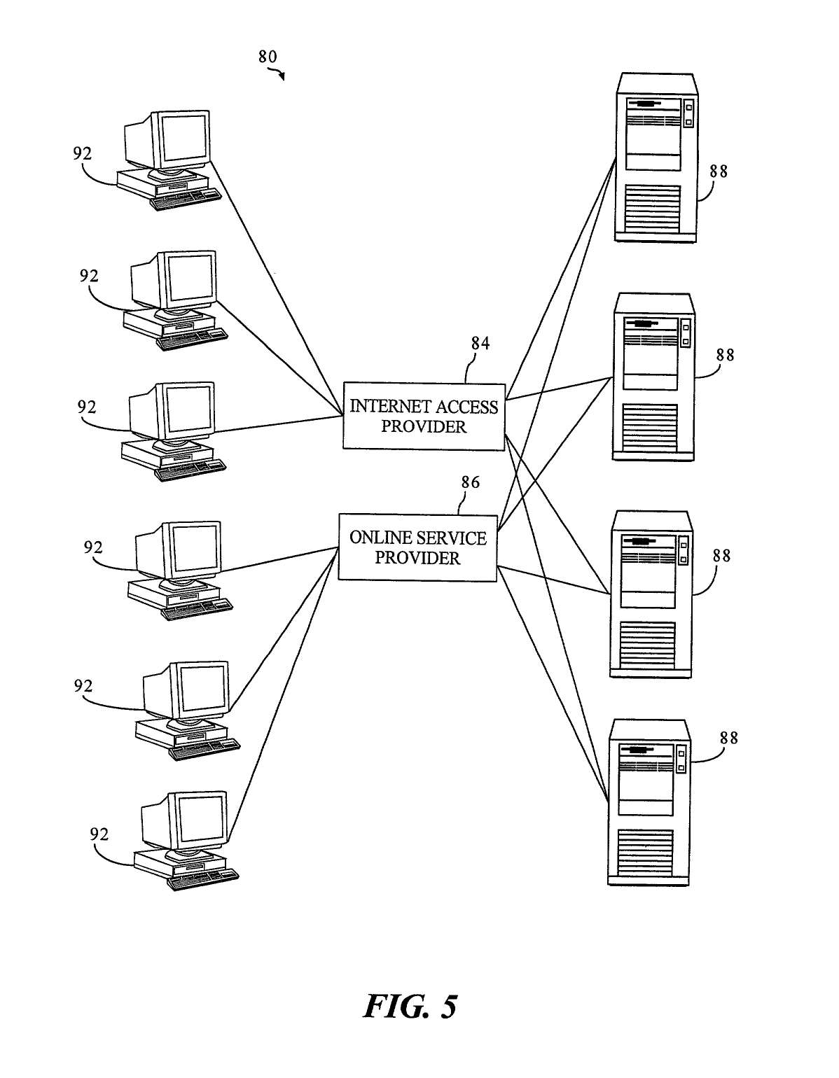

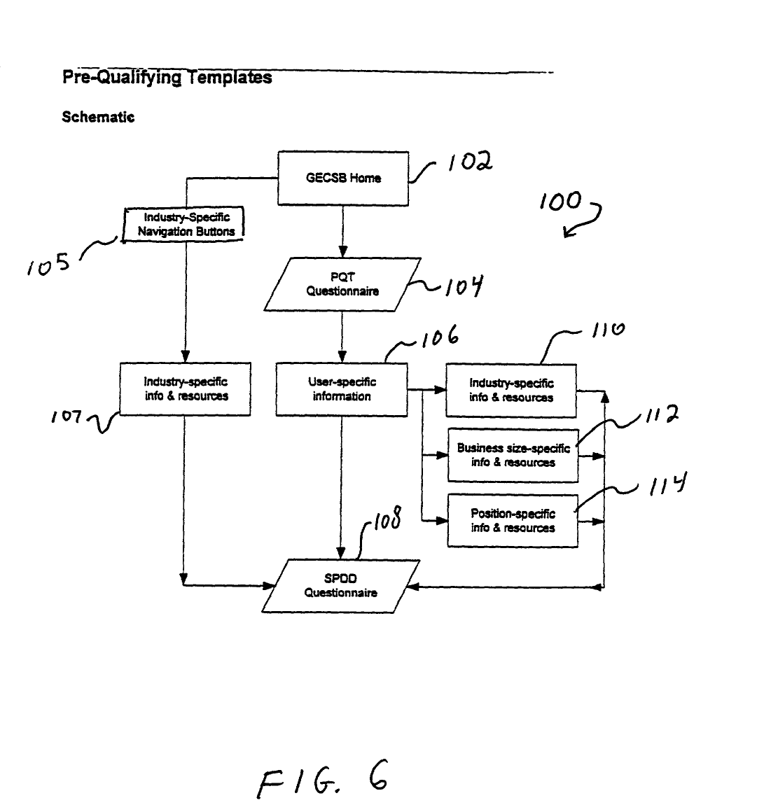

In FIG. 3, FIG. 4, and FIG. 5, like parts are indicated by like numbers.

FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds or newsgroups) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which is interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. Browsers, such as Netscape, can provide the functionality specified under HTTP. “Netscape” is a trademark of Netscape, Inc.

Server 88 executes the corresponding server software, which presents information to the client in the form of HTTP responses 90. The HTTP responses 90 correspond with the web pages represented using HTML, or other data generated by server 88. Server 88 provides HTML 94. With certain browsers, a Common Gateway Interface (CGI) 96 is also provided, which allows the client program to direct server 88 to commence execution of a specified program contained within server 88. This may include a search engine that scans received information in the server for presentation to the user controlling the client.

By utilizing this interface, and HTTP responses 90, server 88 may notify the client of the results of that execution upon completion. Common Gateway Interface (CGI) 96 is one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser.

This is provided by the “fill-in-forms” functionality (i.e., forms 98), that is provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is representative of the Internet, which can be described as a known computer network based on the client-server model discussed herein. Conceptually, the Internet includes a large network of servers 88 that are accessible by clients 92, typically users of personal computers, through some private Internet access provider 84 (e.g., such as Internet America) or an on-line service provider 86 (e.g., such as America On-Line, Prodigy, Juno, and the like). Each of the clients 92 may run a browser to access servers 88 via the access providers. Each server 88 operates a so-called “web site” that supports files in the form of documents and web pages. A network path to servers 88 is identified by a Uniform Resource Locator (URL) having a known syntax for defining a network collection. Computer network 80 can thus be considered a web-based computer network.

Due to the proliferation of web “sites” and advances in electronic commerce endeavors, customers of both large and small enterprises are increasingly demanding web-based solutions for their entrepreneurial, business, and financial needs. In accordance with the present invention, a method and system for a small business web-based portal is described herein. Such a portal provides a user-friendly environment in which marketing, lead generation, and products and services are provided to small business owners over the entire customer life cycle. The present invention, when implemented via the unique web-based portal described herein, provides products and solutions that enable small business owners to “take my business to the next level,” “reduce my costs,” “grow my business,” “protect my business,” and assist with small customer needs. In addition, the method and system of the present invention described herein provides educational and transactional information, and interactive and marketing tools for small business owners.

One embodiment of the present invention provides a single point of contact for information about multiple lines of products, a basic product configurator to help customers identify products that meet their needs, and the ability to capture and distribute critical lead generation information for the sales force. Other embodiments of the present invention includes a Web site having expanded scope and functionality. This embodiment can be said to be customer-centric rather than product-centric. It is believed that small business users of the present invention can achieve a sustainable advantage over time.

The method and system of the present invention can, in various embodiments, provide small business owners with a single point of contact with a product provider, generate and distribute new sales leads from qualified small businesses, and/or cross-market and cross-sell multiple product lines to existing customers. Entities and organizations utilizing the method and system described herein may be involved in any number of industries, such as, for example, health care, wholesale trade, business services, manufacturing, and transportation.

The method and system of the present invention also provides functionality and advantage to both the customer and the selling entity. For the customer, the system may provide, in certain embodiments, access to multiple products through one point of contact as well as management advice and management tools (e.g., finance calculators). Those skilled in the financial and computer networking arks can appreciate that for the selling entity, the method and system described herein can, in certain embodiments, generate incremental new small business leads, foster cross-selling to existing customers, and allow customers to answer basic questions about products and services, thereby reducing the involvement of sales professionals in routine, low value-added activities.

The method and system of the present invention also satisfies a number of business objectives. First, the method and system of the present invention can lower the cost of acquisitions by reducing the sales cycle. Customers are permitted to shop anonymously and educate themselves utilizing the web-based portal (i.e., web portal) described herein. (Note that the term “web portal” or “web-based portal” is utilized interchangeably herein with the term “Small Business Web Portal”.) Second, the method and system of the present invention can lower the cost of service. Providing information, such as a calculator, for example on a web site is significantly less expensive than providing the same information via a phone call. Third, the method and system of the present invention can increase the level of service to the customer by directing the customer to the particular product or information that he or she really is interested in. Moreover, the customer is provided, via the web-based portal described herein, with recognizable solutions, rather than simply a list of products or business units. Customers can also be directed to other vendors providing complementary goods or services.

Portal Functionality

The web-based portal (i.e., the Web site) described herein preferably contains multiple user interactive sections, including for example, a “lead generation” section (i.e., referred to herein as “Lead Generation”), and a brochure section (i.e., referred to herein ad “Brochureware”). Those skilled in the art can appreciate that other sections and areas may be implemented via the method and system described herein. Lead Generation is a broad functional process intended to provide detailed “lead” information to the selling entity about customers who use the site, while at the same time educating those customers in a targeted and personalized fashion regarding how the products and services offered by each of the selling entity's product and service groups may benefit their respective businesses. Brochureware provides online product-specific information services. Brochureware may also incorporate lead generation functionality and dovetail with the Lead Generation process. Other areas of the Web site are discussed herein.

Lead Generation

The Lead Generation process is driven by one or more questionnaires, each preferably followed by increasingly targeted product information pages. As users pass through a series of interactive steps, the information they receive can be narrowed to match their specific business interests, and thus the questions asked of them can become more direct. Four possible steps of the lead generation process are: Pre-Qualifying Templates, Sales Process Drill-Down, Product Configurator, and Online Application, although those skilled in the art can appreciate that other embodiments may incorporate more or fewer steps.

The Pre-Qualifying Templates provide general questions designed to gather basic user information and gauge the relevance of the site to the user, thereby screening out unqualified users and non-potential customers. The user may complete the Pre-Qualifying Templates via at least two techniques. First, the user can complete the Pre-Qualifying Templates utilizing graphically displayed navigational buttons that provide industry-specific information. Such navigational buttons can be graphically displayed at the “homepage” of the web-based portal described herein. Second, the user can complete the Pre-Qualifying Templates by answer a questionnaire displayed at a Web page linked to the homepage of the web-based portal. Those skilled in the art can appreciate that other embodiments may incorporate additional options for completing the Pre-Qualifying Template.

A Sales Process Drill-Down may serve in some embodiments as an intermediate questionnaire, with questions more specific than those in the pre-qualifying templates but less direct than those of the Product Configurator described herein. This section of the web-based portal also permits the user to further tailor his or her experience to his or her own business needs without requiring responses to questions that the user may be uncomfortable answering without a clear rationale. Such questions determine which groups possess products or services relevant to the user, thereby providing the user with a high-level introduction to these products or services.

The Product Configurator can be preferably implemented as a questionnaire that determines which specific products and services may be of greatest interest and utility to the user. The contents of the Product Configurator can be modular, based on the responses of the user to previous questions. The Product Configurator dynamically presents the user with new questions based on previous answers so that user does not have to answer any irrelevant or redundant questions.

The Online Application preferably permits some users to proceed through the all or most of the application process online. For other users, this step may simply generate a more qualified lead from a specific set of questions and answers. Each application/lead can be generated with the option of the selling entity or group to act upon it in an automated or manual process.

Pre-Qualifying Templates

The Pre-Qualifying Templates can be utilized in some embodiments of the present invention to screen out unqualified users and non-potential customers. If the user is not a small business, for example, the site may not be of use to him or her. If a user is from a large business, he or she might be screened out at this stage. Screened-out users either are not allowed access to the site and are re-directed to relevant resources, or may be permitted access to the site, but are not relied upon to generate beneficial lead information.

The Pre-Qualifying Templates may also identify the general product areas that may be of interest to the customer. In order to begin targeting information to the customer, information might be gathered about the business type, size, and position of the user. In certain embodiments, the Pre-Qualifying Templates can function in one of several possible formats on the site, in order to account for user preferences related to how they receive information. Two possible formats for accessing information are product orientation or industry orientation, as examples. Embodiments incorporating each of these are described in detail below.

FIG. 6 depicts a high-level flow chart of operations 102 illustrative of a method for implementing Pre-Qualifying Templates, in accordance with a preferred embodiment of the present invention. As indicated at block 102, the user initially begins at the web-based portal homepage. As illustrated at block 102, the web-based portal homepage is referred as the GE Capital Small Business (GECSB) Home. While viewing the web-based portal homepage, the user is presented with a variety of options for satisfying the requirements of the Pre-Qualifying Templates. The user may, for example, utilize industry-specific navigation buttons graphically displayed at the web-based portal homepage, as indicated at Block 105. In response to “clicking” the graphically displayed industry-specific buttons with a mouse or other pointing device, the user is provided with industry-specific information and resources, as described at block 107. Thereafter, the user is provided with a Sales Process Drill-Down (SPDD) questionnaire, as illustrated at block 108. The Sales Process Drill-Down is described in greater detail herein.

While viewing the web-based portal homepage, as indicated at block 102, the user also is faced with the option of directly filling out a Pre-Qualifying Template (PQT) questionnaire. If the user chooses this option, then as described at block 104, the user is provided with a Pre-Qualifying Template questionnaire. The user thereafter provides user-specific information to the questionnaire, as illustrated at block 106. Assuming that the user does not input industry-specific information and is not provided with resulting industry-specific resources, the user is then directly provided with the Sales Process Drill-Down questionnaire, as indicated at block 108. A similar process also occurs if the user does not provide business size-specific and position-specific information. If the user does provide such information and interactively is referred to resulting resources, then as indicated respectively at blocks 110, 112, 114, the user provides via the Pre-Qualifying Template, industry-specific, business size specific, and position-specific information. This information is thereafter incorporated into the Sales Process Drill-Down questionnaire, as described at block 108.

Product Oriented

If the product orientation format is selected, the user is prompted to “Learn more about . . . ” by linking to a questionnaire that yields targeted information based on the user's responses. In this case the types of questions asked may include, for example, questions regarding company industry, company revenue, position within the company, and zip code. Questions regarding company industry permit the selling entity to make determinations about which products and general information can be of greatest interest to the consumer, based on the industry in which the consumer operates. Acquiring such information early on in a non-intrusive manner yields immediate user profile information and targeted “push” information. A company revenue question is essentially a screening question utilized to assess whether the site can be useful to the customer and whether the customer can make for a useful lead. This question is particularly useful for screening out mid- and high-range businesses. It is also useful for determining what products can be offered to a particular user. A “position within the company” question is a screening question utilized to determine if the user is qualified to make business decisions. For example, a response of “CFO”, “Owner”, or “Fleet Manager” can yield a valuable lead, and allow for targeted push information. Finally, the user is asked to input zip code information. Utilizing user-provided zip code information, software implementing the method and system of the present invention can target, classify, and filter customers by geographic areas

Where a product oriented format is desired, the user might receive multiple resources in response to each of the questions answered. Those skilled in the art can appreciate that in some embodiments these resources can appear in summary form, wherein each resource possesses the option to link to a broader discussion of the topic. The information presented may include, for example, industry-specific information, business size information, job responsibility resources, and/or industry-specific information that refers to information particular to the user's industry. Business size information is information tailored to the user's revenue. Such returned information may be similar or identical in all cases, since targeted businesses may have already been classified as “Small” or “Small to medium”. Job responsibility resources contain information specific to the particular job responsibilities of the user. For example, a CFO might receive information quite distinct from that which a Fleet Manager would receive.

From such resources, the user may seek additional information, such as, for example, information explaining how the provider can assist their business. The user can then proceed to the Sales Process Drill-Down feature of the present invention, and link to a broader discussion of each topic, or link to other available information via the web portal, depending on the needs of the application. For example, a small business owner may link to resources and exploded information useful and specific to his or her industry. Such is information is displayed in an exploded format, a form of display that shows a structure with its part separated but depicted in relation to each other. From this page, the user can again be provided with an opportunity to learn more about the provider's products and services and proceed to the Sales Process Drill-Down.

Industry Oriented

If the customer utilizes industry-specific navigational buttons to enter the site, information is presented to the user in an industry-oriented format. Industry-specific navigational buttons can include, but are not limited to “Manufacturing”, “Transportation”, “Wholesale”, “Retail”, “Professional Services”, and “Health Care”. In this case, questions (2) and (3) above may be asked of the as part of a Sales Process Drill-Down. One purpose for incorporating this separate method of navigation as a part of the Pre-Qualifying Templates is to provide the user, who is primarily interested in industry-specific information, a means for immediate access to targeted information.

The information that the user receives based on his or her responses to the Pre-Qualifying Templates might vary depending upon the navigational method employed. Information at this level may be primarily customer-oriented, emphasizing user resources while introducing the user to products and services in high-level terms.

If the user navigates industry-specific links graphically displayed at the homepage of the web-based portal described herein, the user is presented with an expansive discussion incorporating exploded industry-specific information and resources. Such information can be similar or identical to exploded the industry-specific page described above.

One advantage of the presentation of such Web pages in this manner is that the user can often find that answers to specific questions return targeted and useful information and resources, thereby encouraging the user to proceed through the web-based portal. The exploded discussion page can be valuable as a “second chance” to catch interest of consumers if they are not yet sufficiently motivated to seek product information.

The site can also provide other features wherein users are presented with the option to link to a “Contact Us” page to request more information, allowing them to submit information such as their name, e-mail address, phone number, industry, revenue, and position if such graphically displayed entry fields have not already been provided.

Sales Process Drill Down

Three goals are served by the Sales Process Drill-Down, according to the method and system of the present invention. First, it is necessary to present intermediate-level questions to the user that are more specific than those questions presented to the user in aforementioned the Pre-Qualifying Templates. These questions, while more specific than those asked in the Pre-Qualifying Templates, are less direct than those presented to the user via the Product Configurator. It is important to present intermediate-level questions in this manner because the user must feel comfortable that this level of questioning possesses a justifiable and obvious rationale for proceeding, which can benefit him or her.

Second, it is necessary to identify the types of products that can benefit the user. For example, if a manufacturer does not offer benefits to all employees and does not use cars as a part of his or her business, then certain products and services may be relevant whereas others may not. This permits the web-based portal or site to further refine the customers profile and push relevant information.

Third, and perhaps most important, it is necessary to generate a lead. The user is asked to provide his or name and e-mail address, thereby resulting in a useful lead on which the supporting sales team and individual selling entities may follow up. Such information can be entered by the user via a entry field displayed with the graphical environment of the web-based portal.

The method and system of present invention, as implemented by the web-based portal described herein, prompts the user, based on the information returned in the previous step, to seek additional information describing how a selling entity can benefit their business. When the user clicks on a graphically displayed hyperlink, the Sales Process Drill-Down questionnaire appears, with the prompt: “First help us understand your business needs better”.

The user is then preferably required to answer all questions. If the user did not previously answer questions addressing industry type, revenue, or their position in the Pre-Qualifying Templates, the user is required to do so now. The user is thus prompted to enter his or her name and e-mail address for lead generation. The user is also asked to provide the number of employees in his or her company. A graphically displayed drop down list or an actual number that is compared against a list of ranges is presented to the user. Such information is utilized to better evaluate the business size. This question need not be asked directly in the Pre-Qualifying Templates because the user may view it as too intrusive that early in the process. Such a question might be more appropriate at this point because the user can appreciate that in order to receive targeted information, additional specific questions must be asked. This question might be necessary if some entities require a specific measure of the employee base.

The user is also prompted to provide information related to lines of credit. Such data can be entered by the user via a graphically displayed check list, text entry box, or drop down list. Additionally, the user is prompted to provide information describing whether or not he or she has an immediate need for financing. Such information is useful for determining if loan or credit services offered by certain providers can be of assistance to the customer's business. Other questions that the user is prompted to answer include whether or not vehicles are a necessary part of the user's business. Such information is useful for determining whether fleet service providers would or would not benefit the customer's business.

The customer is also asked to provide information indicating whether or not a need exists for the provision of telecommunications services. Such information is required to determine if particular telecom services may be useful to the customer's business. Finally, the customer is asked is provide information indicating the type of benefits currently offered to his or her employees, in order to determine if such benefits would be of use to the customer's business.

Resulting information is then returned to the user, incorporating previous responses from the user's compiled profile. Information provided at this level can be more product-oriented, informing the customer of services offered by various providers and whether such services are beneficial to his or her business. The customer can be prompted to seek additional information related to those products or services best suited to his or her needs (i.e., Product Configurator). The customer can be additionally presented with the option to link pages containing product information from the respective providers. Such information may include, for example, case studies, testimonials, descriptions, a glossary of terms, calculators, applications, tutorials, training programs, and so forth.

The information and resources now available to the user continue the earlier targeted discussions, while identifying specific product areas that maybe of interest. To continue an earlier example, a manufacturer may have indicated that he or she has forty employees, an annual revenue of $1.8 million, sufficient credit, a need for financing, but does not use a fleet of cars, lacks a need for telecom services, and does not offer comprehensive benefits to all employees. For this customer, certain products and services can be useful, while others may not.

Other features implemented in accordance with the present invention provide users with the option to link to a “Contact Us” page at any time to request additional information, allowing them to submit their name, e-mail address, phone number, industry, revenue, and position if such user entry fields have not already been graphically provided.

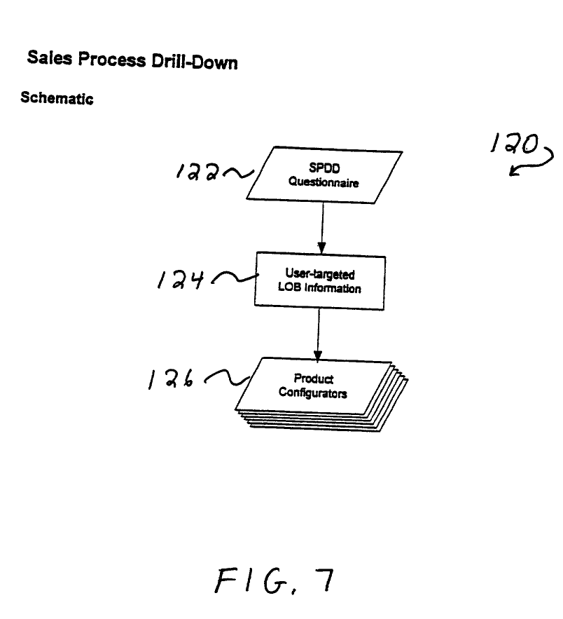

FIG. 7 thus illustrates a high-level flow chart of operations 120 illustrative of a method for implementing the Sales Process Drill-Down, in accordance with a preferred embodiment of the present invention. As indicated at block 122, the user completes the Sales Process Drill-Down questionnaire, according to the methodology described above. Those skilled in the art can appreciate that the operation described at block 122 is analogous to the operation described in block 108 of FIG. 6 herein. Thereafter, as illustrated at block 124, having incorporated all previous responses in the user's profile, the user is provided with general line of business (LOB) information that may be useful to his or small business or enterprise. The user is then prompted to seek additional information related to those products best suited to his or her needs by accessing the Product Configurator, as indicated at block 126. The Product Configurator is described in greater detail herein.

The Product Configurator identifies and promotes specific products and services. It is assumed at this stage that the user is interested in finding out which specific products and services offered by the various providers are most useful and appropriate for his or her business. It is one function of the Product Configurator to provide such directly targeted information. The Product Configurator can also build a detailed lead. After reviewing specifically recommended products and services, users may decide not to proceed to an application. The Product Configurator can gather detailed information about the user, allowing the sales team or providers to take the initiative and follow up with the user, if necessary, at a later date.

Users can be prompted, based on the information returned to them in the previous step, to learn which products and services are right for their businesses. Users can be provided with the option to choose from among any or all of the product areas returned. The questions asked by the Product Configurator can be designed in a modular fashion, so that the user can answer questions for any selected provider, while questions germane only to other products and services do not appear.

Additionally, certain questions may open one or more hyperlinks to Web pages containing explanatory information. For example, a user may not understand the difference between term and individual life insurance. Clicking on a graphically displayed button with the words “What's this?” initiates the opening of an explanation of these insurance benefits in a frame set or separate pop-up window of the web-based portal graphical environment. A graphically displayed button of this type may be particularly important where questions in the Product Configurator invoke arcane or uncommon terminology that may confuse the user. Such explanatory text can result in a more satisfying user experience, while increasing the reliability of generated lead information.

An example of various types of questions that can be asked of customers interested in particular products and services, along with examples of user input, include the question, “What benefits would you like to offer your employees?” A checklist is graphically displayed for the user. Users choose from among benefits, such as “Term Life”, “Universal Life, “STD/LTD”, or “Dental”. Additionally, sub-selections can be graphically presented to the user. For example, under “STD/LTD” additional selections, such as “Accident,” “Sickness,” “Off-the-Job,” or “On and Off-the-Job” can be provided to the user. Such a question directly assesses products that are right for the individual user.

Another example of a question that can be asked of a customer interested in particular products and services, along with user input, is the question, “What payment agreement would you prefer?” To assist the user in answering this question, radio buttons can be graphically displayed for the user within the web-based portal. The user selects radio buttons associated with the phrases “Company pays all or part” or “Employee pays”. Again, those skilled in the art can appreciate such a question is directly relevant to the products that best serve the user.

Radio buttons, well-known in the art of graphical user interface environments, such as the graphical interface environment of the web-based portal described herein, are graphical icons or graphical buttons that permit users to select one of several options, typically within a dialog box. A radio button usually is graphically displayed as a small circle that, when selected, has a smaller, filled circle inside it. Selecting one button in a set deselects the previously selected button, so one and only one of the options in the set can be selected at a particular time.

Thereafter, the user receives direct information describing the products and services best suited for his or her business. In a preferred embodiment of the present invention, all products that have not been ruled out by the questionnaires can be graphically displayed for the user. The user is then provided with the option of filling out a graphically displayed form that permits him or her to either apply for any selected product or service or send in a well-qualified lead.

The user can be additionally presented with the option to link to a “Contact Us” page at any time to request more information, allowing him or her to submit a name, e-mail address, phone number, industry, revenue, and position if these fields were not earlier provided.

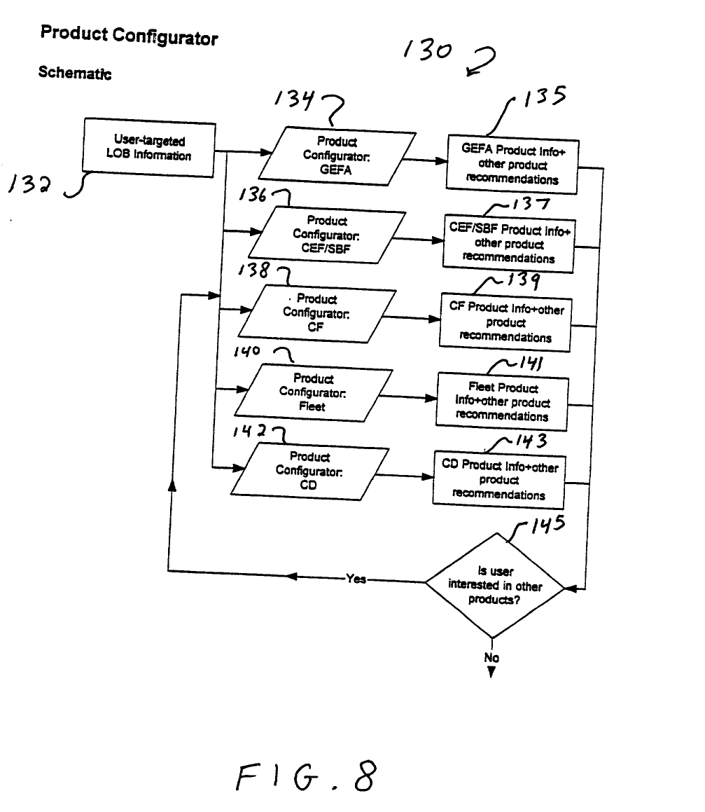

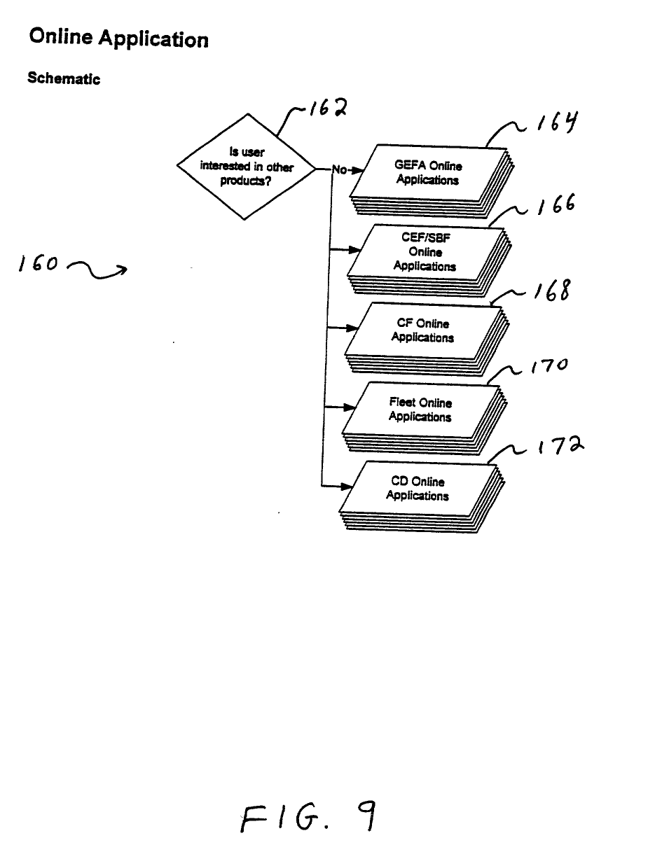

FIG. 8 depicts a high-level flow chart of operations illustrative of a method for implementing the Product Configurator, in accordance with a preferred embodiment of the present invention. As indicated at block 132, once user-targeted line of business (LOB) information is gathered, the Product Configurator can provide directly targeted information to the user. Those skilled in the art can appreciate that the operation described at block 132 is analogous to the operation illustrated at block 124 of FIG. 7 herein. The user may be prompted to learn more about which products can assist their business. The user can choose from among a variety of options, as indicated respectively at blocks 134, 136, 138, 140, and 142, including GEFA (General Electric Financial Assurance), CAF/SBF/Tilden (Commercial Asset Finance, Small Business Finance/Tilden), CF (Commecial Financial), Fleet, and CD (Commercial Direct).

Note that these acronyms (e.g., GEFA, etc.) represent example business units and services that a user may choose through the web-based portal described herein. Those skilled in the art can appreciate that these particular business units and/or entities/services represent merely a few examples of options that may be chosen by a user, in accordance with the invention described herein. Such services/business options are not limiting features of the invention. GEFA, for example, is a type of organization that provides quality assurance services. Likewise, CAF is an organization that provides commercial asset finance services, such as equipment leasing for big ticket items over $150,000. SBF provides small business financial services, such as SBA (Small Business Administration) loan guaranties. Tilden is the name of an organization that provides small ticket item leasing and related services, generally under $150,000 in value. Fleet services include vehicle leasing, financing, and other related services, while CD (i.e., commercial direct) offers corporate credit cards.

Thus, in response to choosing the GEFA option, as illustrated at block 134, the user is provided with GEFA product and related recommendations, as indicated at block 135. Likewise, in response to choosing the CAF/SBF/Tildent option, as depicted at block 136, the user is provided with CAF/SBF/Tiden product and related recommendations, as described thereafter at block 137. In response to choosing the CF option, as indicated at block 138, the user is provided with CF product and related recommendations, as illustrated at block 139. In response to choosing the Fleet option, as depicted at block 140, the user is provided with Fleet product and related recommendations as indicated at block 141.

In response to choosing the CD option, as described at block 142, the user is provided with CD product and related recommendations, as illustrated at block 143. Thereafter, as depicted at decision block 145, a determination must be made as to whether or not the user is interested in other products. If it is determined that the user is interested in other products, then the user is prompted to choose additional product information and recommendations via the Product Configurator. Otherwise, the user no longer has a need to utilize the Product Configurator.

Based on the foregoing, those skilled in the art can appreciate that the Product Configurator operates according to a general methodology wherein initially a user profile based on user-provided information and user-tailored information is developed. Such user-provided information can be composed of business information directly related to the user's business or enterprise. The user-tailored information is based on responses that the user provided earlier via an electronic template or questionnaire. Once a user profile is developed, the user profile is transmitted to the Product Configurator, which can be implemented in the form a software module or series of such modules. The user profile is then automatically analyzed via said Product Configurator to interactively provide user-tailored product information to the user, based on the user profile. The user-tailored product information is then interactively rendered in the web-based portal within a web browser, in response to analyzing the user profile via said Product Configurator.

Online Application

The Online Application serves one of several purposes, depending upon the interests of the providers. For example, the Online Application provides customer convenience, because it provides the customer with a convenient manner of applying for products and services offered by the providers. In some cases the application may be sent electronically, while in others the user may download a printable file, which the user may then mail to the provider. Information garnered through this effort would be complete and detailed.

The Online Application also provides qualified lead generation. The user may alternately fill out an electronic form providing detailed information to the Sales Team or providers for their follow-up. Such an online electronic form can be reasonably called an “application” and all products and services can offer one if they do not offer a download or printable file, as described above. The questions that appear on an application are thus determined by the needs of the providers.

FIG. 9 illustrates a high-level flow chart of operations 160 illustrative of a method for implementing an Online Application, in accordance with a preferred embodiment of the present invention. As indicated at decision block 162, a determination must be made as to whether or not the user is interested in other products. Those skilled in the art can appreciate that decision block 162 is analogous to decision block 145 of FIG. 8. Decision block 145 of FIG. 8 represents the final operational step necessary to implement the Product Configurator. When the user no longer requires access to the Product Configurator, the user is then ready to proceed to fill out the Online Application. Thus, once it is determined that the user is not interested in other products, the user can fill out a variety of online applications, including GEFA online applications, as illustrated at block 164, CAF/SBF/Tilden online applications, as depicted at block 166, CF online applications, as indicated at block 168, Fleet online applications, as illustrated at block 170, and CD online applications, as indicated at block 172.

Brochureware

The Brochureware is beneficial to users seeking specific information about a particular product; however, their access to this information may not be direct. In certain embodiments, important restrictions to their mobility to access particular pages, sections, or areas of the web-based portal or site may be implemented. The user can be screened via screening process in the Pre-qualifying Template. Such a screen process is important because it ensures that the user finds relevant information, while verifying the value of any lead generated from the customer's profile. Therefore, a screening process may be utilized in association with the Brochureware to ensure that the user is an authorizing officer of relevant industry.

Another restriction to user mobility applies to the generation of lead information. The user may be required to generate lead information. If users have direct access to product information, the site may lose valuable lead information. In certain embodiments, the user can be required to build a user profile first. One aim of bundling Brochureware with the web-based portal or site, however, is to simplify and expedite the browsing process. The breadth of any questionnaire should therefore take into account the user's interest in efficiency.

Another goal of the web-based portal is to provide a unified resource for all of the lines of the business that compose the provider group. Users may be exposed to all relevant product information, if desired.

The Brochureware may be accessible via navigation buttons displayed on the homepage. The buttons can be labeled in general terms, encompassing a broad range of products. They could be grouped, for example, according to a range of categories, including loans, leases, credit, fleet services, and benefits packages. The “Loans” category encompasses products and services offered by financial providers. The “Leases” category may include products and services (e.g., equipment leasing) offered by financial providers. The “credit” category can encompass products and services offered by credit providers. The “Fleet Services” category encompasses products and services offered by fleet services. This redundancy may be necessary where the user may not be looking specifically for a lease. Finally, the “Benefits Packages” category encompasses products and services offered by benefits services providers.

In a preferred embodiment of the present invention, navigating utilizing the Brochureware buttons can bring the user to an information-based page wherein high-level descriptions of corresponding products and services offered by the providers are available for the user. The user can then link from these pages to pages with broader descriptions of product lines.

As mentioned above, the questionnaire is preferably sufficient in breadth to generate a specific profile yet brief enough to avoid discouraging the user. The preferred approach is to divide the user's access to brochure information into two sequential parts, each preceded by a questionnaire. The first set of questions may, for example, return direct information about requested provider's products and services, and give the user exposure to other products or services that may be of interest to him or her. Because the user is requesting direct information, it is reasonable to ask more direct questions at this stage. The questionnaire can therefore function as a consolidation of the Pre-Qualifying Templates and the Sales Process Drill-Down. Asking the questions found in the Product Configurator at this point could make the questionnaire overly cumbersome and may discourage usage.

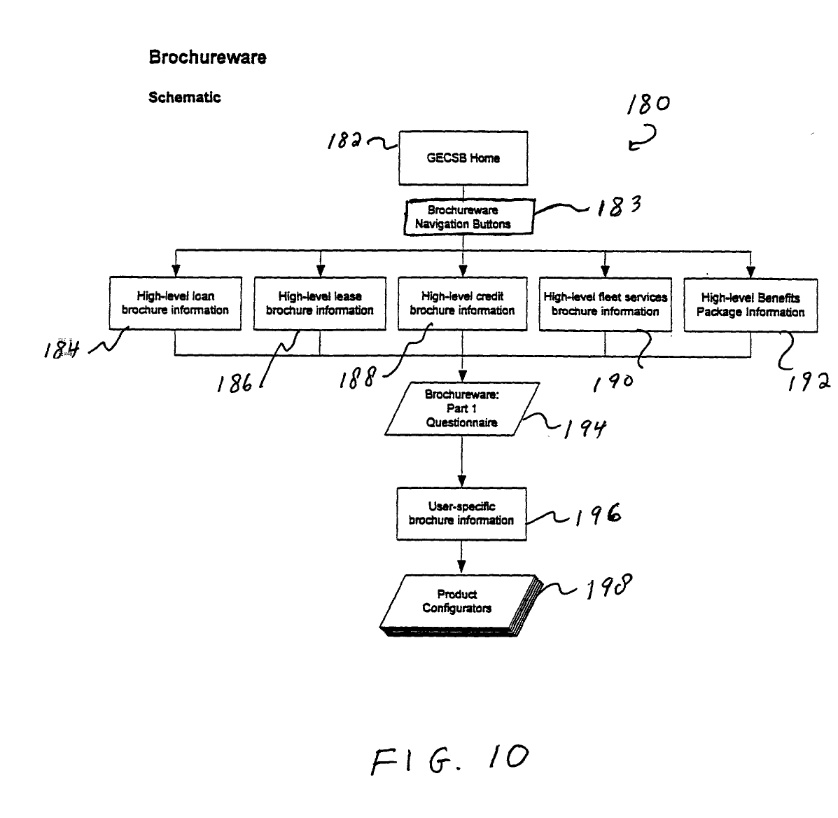

FIG. 10 depicts a high-level flow chart of operations 180 illustrative of a method for implementing the Brochureware section described above, in accordance with a preferred embodiment of the present invention. As illustrated at block 182, the user view the web-based portal homepage. Those skilled in the art can appreciate that the operation described at block 182 is analogous to the operation described at block 102 of FIG. 6. Utilizing Brochureware navigation buttons graphically displayed on the web-based portal homepage, as indicated at block 183, the user can access information-based pages containing high-level brochure information. Thus, as indicated at block 184, the user may access high-level loan brochure information, in response to “clicking” a graphically displayed navigation button hyper linked to an appropriate homepage. Similar operations can occur to access high-level lease, credit, fleet services, and benefits package brochure information as respectively depicted at blocks 186, 188, 190, and 192.

As illustrated thereafter at block 194, the first questionnaire provided by the Brochure application can be implemented as a combination of the product oriented Pre-Qualifying Templates and the Sales Process Drill-Down. It may, preferably, require the user to build a profile sufficient for a detailed lead, including, for example, information such as name and e-mail address, industry, number of employees in the company, the user's position within the company, the company's annual revenue, lines of credit, whether or not an immediate need for financing exists, whether there is a need for vehicles or telecommunications services, and finally, the benefits offered to the employees of the company.

The information returned to the user can directly address the requested product information and push relevant products from other providers, as indicated thereafter at block 196. Users have the opportunity to select either any one or several of the products that may interest them. Following completion of the operation described at block 196, the user is then returned to the Product Configurator, as indicated at block 198.

Those skilled in the art can appreciate that after entry of the requested information, the Brochureware process dovetails with the regular Lead Generation process. Other questions and information can be solicited thereafter. The format and information required can be similar or identical to those described under the Product Configurator section above.

Users can additionally be provided with the option to link to a “Contact Us” page at certain times to request more information, allowing them to submit their name, e-mail address, phone number, industry, revenue, and position if these fields have not already been provided.

Other Site Areas

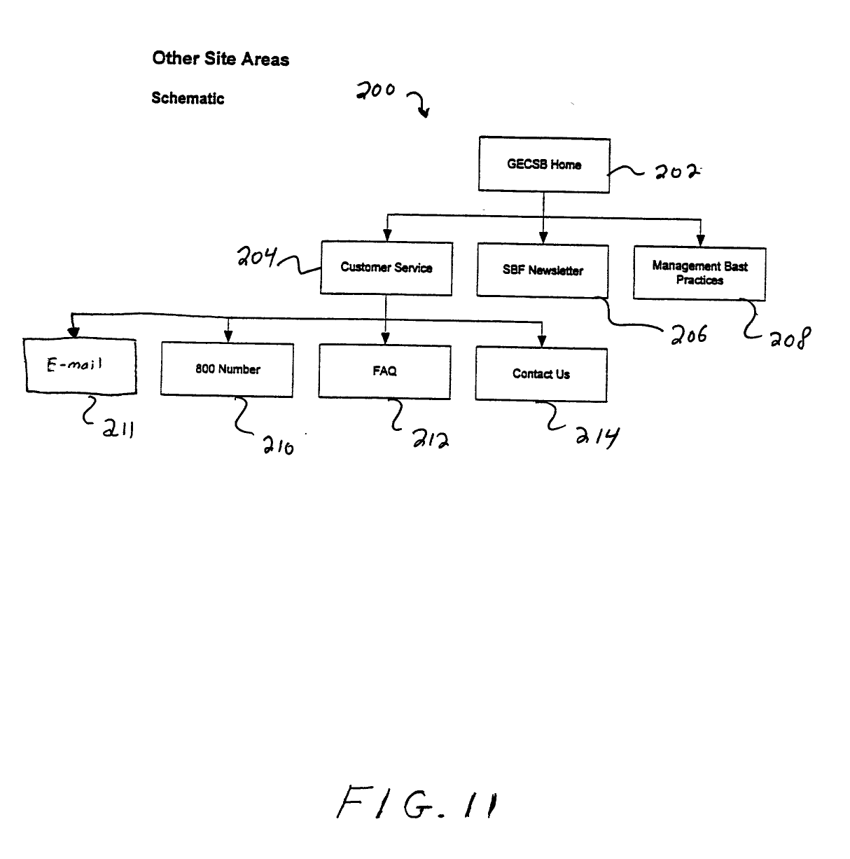

FIG. 11 illustrates a high-level flow chart of operations 200 illustrative of a method for implementing other web-based portal or site areas, in accordance with a preferred embodiment of the present invention. As illustrated at block 202, the user can access the web-based portal homepage. Those skilled in the art can appreciate that the operation depicted at block 202 is analogous to the operation illustrated at block of FIG. 6. The user can access several additional areas or sections from the web-based portal home page, including a customer service section, as indicated at block 204.

The customer service section can provide users with easy access to providers and answers to basic questions. Users can contact the customer service section via, for example, a navigational bar graphically displayed on the homepage of the web-based portal. This area can be composed of several parts, including, for example, an “Online FAQS” section, as indicated at block 212, an E-mail section, as indicated at block 211, a section posting 800 telephone number as indicated at block 210, or a contact section, as described at block 214,

The “Online FAQS” section presents answers to frequently asked questions about providers, their products and services, and the use of the web-based portal. The E-mail section is a graphically displayed form that permits users to send E-mail messages to providers. The contact section, labeled as “Contact Us” includes addresses and telephone numbers of providers, their lines of business, and a sales support team, if applicable, allowing users direct access to the various relevant offices. Additionally, online text of a newsletter, as illustrated at block 206, and/or management best practices, as depicted at block 208, are accessible from a navigational bar graphically displayed on the web-based portal homepage.

The present invention also permits users to obtain product information and generate leads for all lines of business by collecting entered user information saving it to a database, as well as forwarding this information to the appropriate business unit. Distribution of such information to the business units can be accomplished via electronic mail. The user information is preferably stored in a database, such as for example, an Oracle database. In a preferred embodiment of the present invention, provider-end users can employ a Web tool to view the data in the database.

Architecture

The method and system of the present invention, implemented as a program product in software form, can be hosted on one or more servers. The program product is preferably hosted on two or more UNIX machines, one or more front end web servers and one or more back end database machines running an operating system, such as the Solaris 2.6 operating system. In a preferred embodiment of the present invention, the front end application machine operates with the following installed software items:

1. Web Server: Netscape Enterprise Server, version 3.6

2. Java Servlet Runner: Jrun, version 2.6

3. Java Servlet Development Kit, version 2.0

4. K shell script daemon

The back end database machine, in accordance with a preferred embodiment of the present invention, can function with the following software item installed: Oracle Database, version 8.04.

Those skilled in the art can appreciate that the above-referenced software packages can be utilized to implement a preferred embodiment of the present invention. “Java” is a programming language that permits programs to be written in such a manner that users can safely download Java-written programs from the Internet to their computers without fear of also downloading viruses. Utilizing small Java programs referred to as applets, Web pages can incorporate sound, animation, games, and other interactive functions. Web browsers typically utilize Java interpreters to run Java applications downloaded from Internet Web Pages.

The connection between the front end and back end machines can employee a number of standard connection architectures, but generally utilizes ethernet TCP/IP. The front end machine is preferably connected to the Internet, via TCP/IP, such that the web server handles standard HTTP protocol, well known in the Internet and computer networking arts. Both the front and back end machines can be hosted by a provider or an agent maintaining the system on behalf of the providers.

A variety of database tables can be utilized in accordance with a preferred embodiment of the present invention. For example, a customer table containing customer general information can be utilized, such that a compiled and generated user profile is pulled from such a table. A rules table can also be implemented containing business rules and associated hyperlinks to files to be returned if the rule is true. A content table can also be implemented such that the content table contains the actual content which can be returned to the user to create a dynamic page.

A transaction table maintaining all user transactions can be utilized, for example, to store all calculated values generated from a calculator. This can only occur if the user specifies that data is to be saved. Other tables which can be utilized in accordance with a preferred embodiment of the present invention include an industry table holding the industry name and code for each customer, and a zip code table holding all zip codes and state names. In addition, a “line of business” table maintaining line of business names and customer identification can also be implemented in accordance with the present invention.

A Software Component utilized in accordance with the web-based portal described herein preferably utilizes JavaScript and Java Servlets to power the functionality of this site. JavaScript is used to enforce the business rules associated with the particular form with which they are currently associated (i.e., client side). Those skilled in the art can appreciate that JavaScript is a scripting language developed by Netscape Communications and Sun Microsystems Inc. that is loosely related to Java. The forms provide the core user interface for the following functions: Pre-Defined Templates, Online Application, and Sales Process Drill-Down. Java Servlets are utilized to organize gathered form information, communicate with the business tier, and thereafter return a desired result set enforced by the business objects. Java Business Objects are classes that represent the business logic tier for this system.

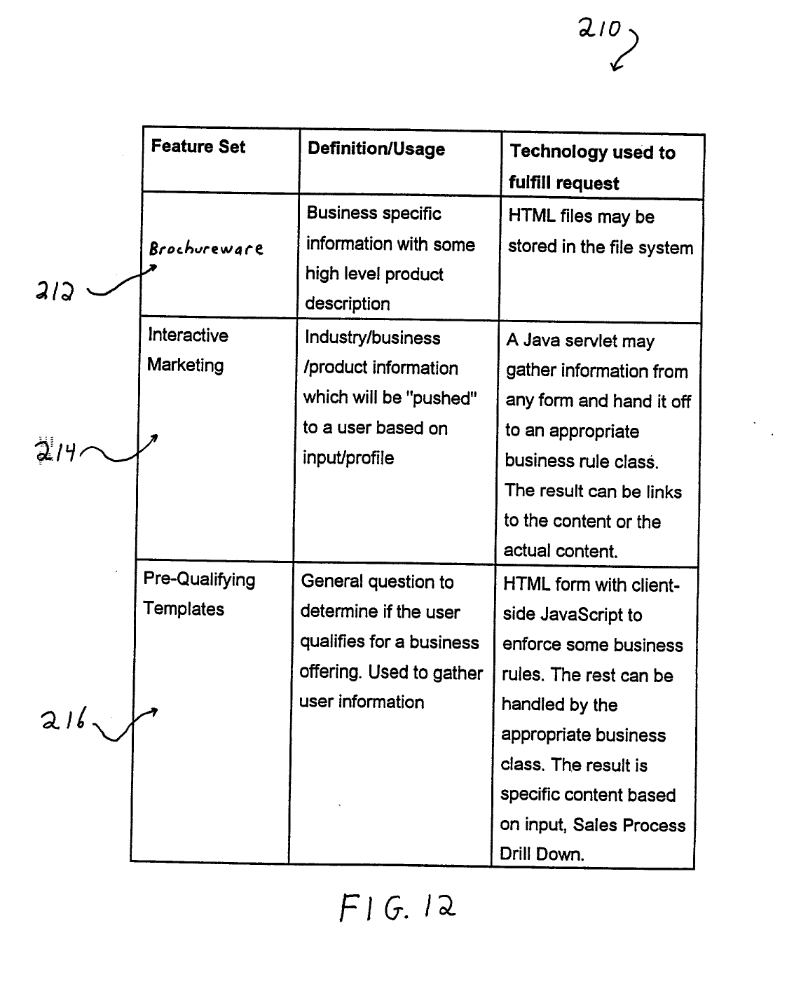

FIG. 12 to FIG. 14 illustrate tables that provide a summary of the functional components of the web-based portal present invention. FIG. 12 depicts a table 210 summarizing functional components utilized in accordance with a preferred embodiment of the present invention. As depicted at row 212 of FIG. 212, the feature set “Brochureware” is defined as business specific information with some high level product description. HTML files may be stored in the file system associated with the web-based portal. As illustrated at row 214, “Interactive Marketing” is defined as industry, business, and product information that can be “pushed” to a user based on user input or user profiles. A Java Servlet can be utilized to gather information from any form filled out by the user. This information is handed to an appropriate business rule class. The compiled result can be displayed for the user in the form of hyperlinks to pages containing appropriate content.

As depicted at row 216, “Pre-Qualifying Templates” are defined as general questions asked to determine if the user qualifies for a business offering. Such questions are utilized to gather user information. Again, HTML is utilized as the base technology. The forms that compose the Pre-Qualifying Templates rely on HTML with client-side JavaScript to enforce some business rules. Remaining portions of the Pre-Qualifying Templates can be handled by appropriate business classes. Resulting information is composed of specific content based on input, and information obtained from the user via Sales Process Drill Down methodology described herein.

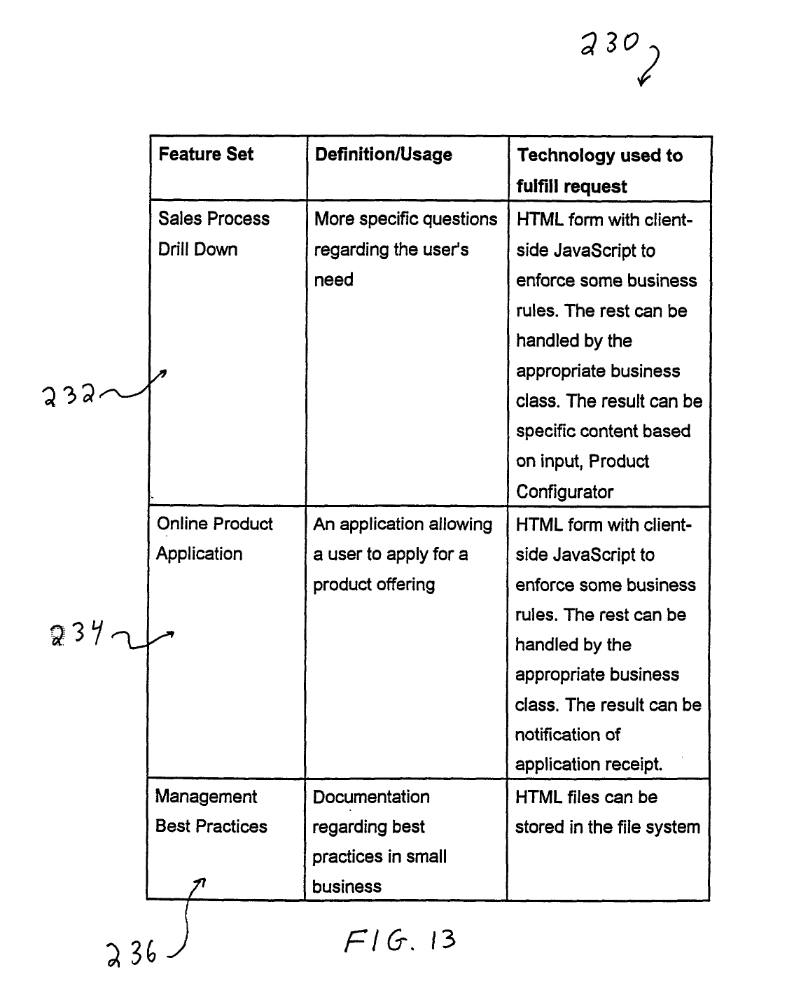

FIG. 13 illustrates a table 230 summarizing additional functional components utilized in accordance with a preferred embodiment of the present invention. As depicted at row 232, the “Sales Process Drill Down” is defined as composing increasingly detailed and specific questions relating to the needs of the user. The form accessed by the user to participate in the Sales Process Drill Down relies on an HTML form with client-side JavaScript to enforce some business rules. Remaining content can be handled by the appropriate business class. Resulting information is composed of specified content based on input and information obtained from the user via the Product Configurator described herein.

As illustrated at row 234, the “Online Product Application” is defined as an application that permits a user to apply for a product offering. Information is gathered from the client via an HTML form with client-side JavaScript to enforce some business rules. Remaining content can be handled by the appropriate business class. As a result of processing the information input by the user via the Online Product Application (i.e. Online Application described herein), notification of application receipt is generated. As described at row 236, “Management Best Practices” is defined as documentation regarding the best practices in small business. Such information is stored as HTML files in a file system associated with the Small Business Web Portal described herein.

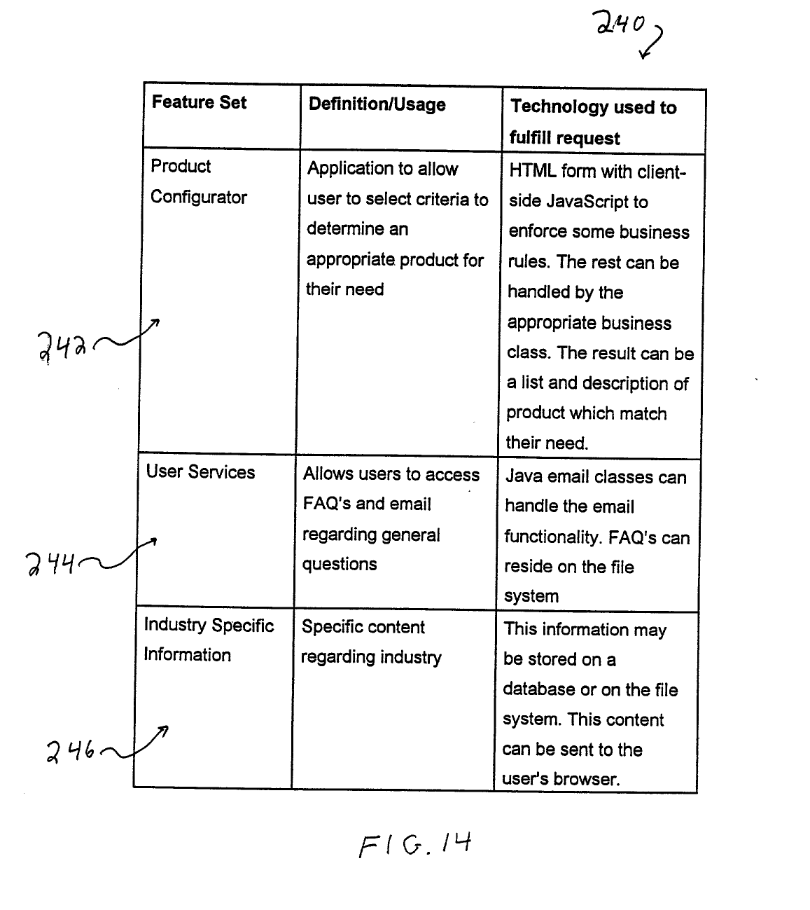

FIG. 14 depicts a table 240 summarizing additional functional components utilized in accordance with a preferred embodiment of the present invention. As illustrated at row 242, the “Product Configurator” is defined as an application that allows users to select criteria for determining appropriate products for their small business or entrepreneurial needs. Input is handled via an HTML form with client-side JavaScript to enforce some business rules. Remaining content is handled by the appropriate business class. A list and description of products that match the needs of the user are generated as a result of processing information entered by the user in the Product Configurator application.

As described at row 244, “User Services” are defined as services that allow users access to facts and e-mail the owners of the Small Business Web Portal with general questions. Java e-mail classes are utilized to handle e-mail functionality. Facts (i.e. “FAQS” or “FAQ's”) reside on the file system associated with the Small Business Web Portal. As illustrated at row 246, “Industry Specific Information” is defined specific content about an industry. Such information can be stored on a database or file system associated with the web-based portal. This content can be forwarded to the user's web browser.

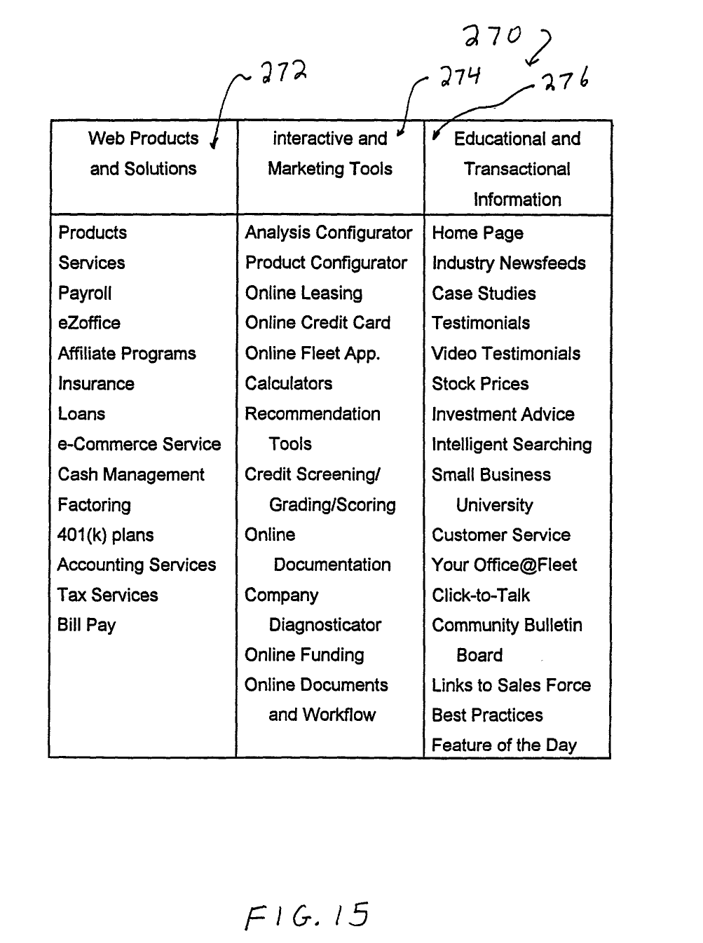

FIG. 15 illustrates a table 270 summarizing products, solutions, tools and education and transactional information that may be accessed via the method and system described herein, in accordance with a preferred embodiment of the present invention. Table 15 is divided according to columns 272, 274 and 276. Column 272 lists “Web Products and Solutions” that can be accessed via the web-based portal described herein. Column 274 provides a list of “Interactive and Marketing Tools” that are also available via the Small Business Web Portal. Finally, column 276 provides a list of “Educational and Transactional Information” available via the Small Business Web Portal.

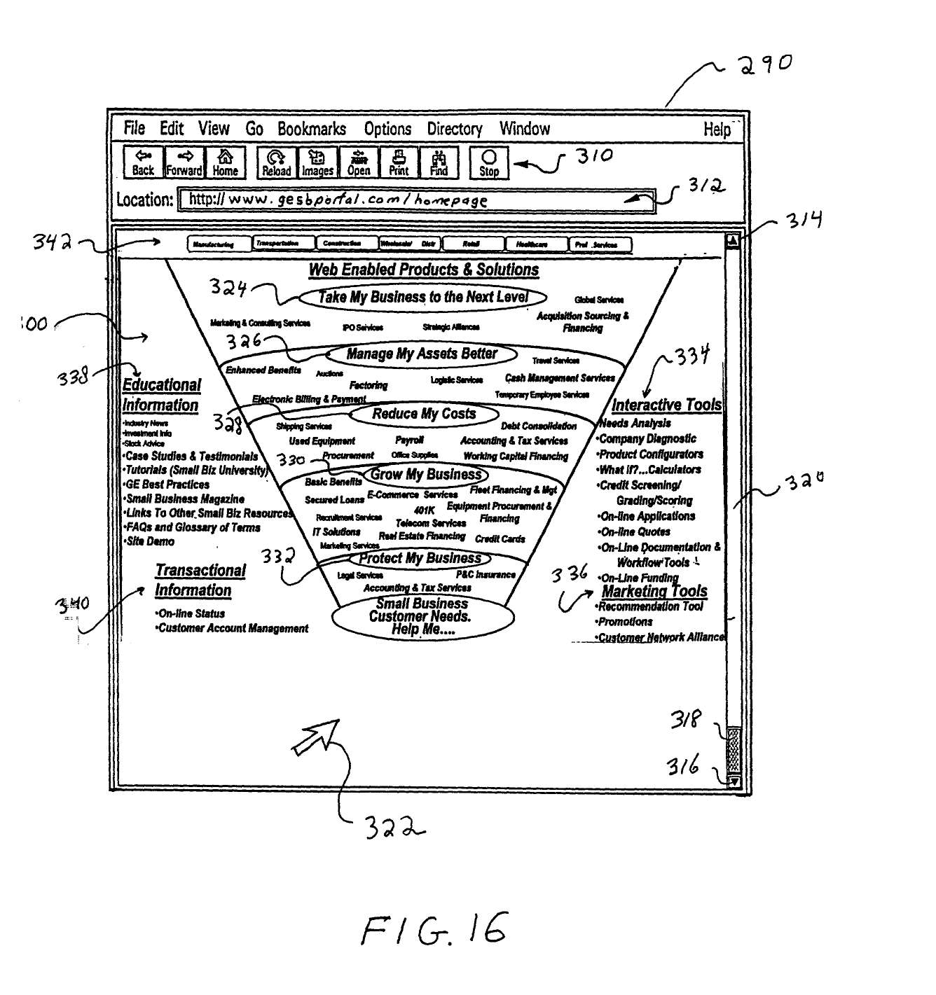

FIG. 16 depicts a Small Business Web Portal homepage 300 displayed within a web browser graphical user interface window, in accordance with a preferred embodiment of the present invention. Those skilled in the Internet and computer networking arts can appreciate that the term “homepage” refers simply to a primary page of an Internet web-based portal or site. Subsets or specific related areas are referred to simply as “pages”. FIG. 16 illustrates a web browser-based graphical user interface window 290 in which the homepage 300 is displayed. Window 290 displays a web browser application. Homepage 300 is located within window 290. Icons 310 are displayed within the web browser application which permit a user to implement web browser commands. In graphical user interface environments, icons are typically small graphical images displayed to represent objects that can be manipulated by a user via a pointing device such as a mouse. Homepage 300 is one of many web pages that together compose the Small Business Web Portal of the present invention. Homepage 400 corresponds to the URL http://www.gesbportal/homepage as indicated at 312. Note that the URL http://www.gesbportal/homepage is utilized herein for illustrative purposes only. Other features of web browser window 290 well-known in the Internet and computer networking arts include scroll arrows 314 and 316 and elevator 318. Scroll arrows 314 and 316 permit a user to scroll up or down through homepage 400, while elevator 318 allows a user to move up and down in homepage 400 with decreasing granularity, thereby scanning a larger portion of homepage 400 than permissible with scroll arrows 314 and 316. Cursor 32 is an on-screen icon, well known in the Internet and computer networking arts that moves with associated movements of a mouse or other pointing device.

Thus, a user can move cursor 32 to an appropriate position within homepage 400 to access Web enabled products and solutions, according to the method and system described herein. Homepage 400 is divided into various financial and business categories that a user can access according to his or her needs. For example, under the category “Take My Business to the Next Level” as indicated at 324, the user can “click” sub-categories, such as marketing and consulting services, IPO Services, strategic alliances, global services, and acquisition sourcing and financing”. These terms are hyper linked to associated pages.

In addition, the user can choose the category, “Manage My Assets Better” as indicated at 326, and access pages containing information and applications for enhanced benefits, auctions, factoring, electronic billing/payment, logistic services, travel services, cash management services, and acquisition sourcing & financing. By searching under the category “Reduce my Costs,” as illustrated at 328, the user can choose hyper linked pages containing information and applications related to shipping services, used equipment, procurement, payroll, office supplies, debt consolidation, accounting and tax Services, and working capital financing”.

By searching under the category, “Grow My Business,” as illustrated at 330, the user can access hyper linked pages related to topics and applications concerning basic benefits, secured loans, recruitment services, IT Solutions, marketing services, E-commerce services, 401K retirement and savings information, telecommunications (telecom) services, real estate financing, fleet financing and management, equipment procurement and financing, and credit cards.

As illustrated at 332, the category “Protect My Business” includes links to pages containing applications and information for legal services, accounting and tax services, and insurance. Homepage 300 also displays a variety of links to other applications and tools, including interactive tools 334, marketing tools 336, education information 338, and transaction information 340. Icons 342 permit the user to link to pages categorized according to particular industry topics, such as manufacturing, transportation, construction, wholesale distribution, retail, healthcare, and professional services.

Based on the foregoing, those skilled in the art can appreciate that the web-based portal described herein operates according to a general method and system, and as such, can be implemented as a series of modules or instruction modules that make up a particular program product. Thus, user tailored information is provided to a user via a web-based portal within a remote computer network, such as the Internet. User-provided information is compiled via an interactive template within said web-based portal. Such a template can be implemented in the form of a questionnaire or series of templates and questionnaire depending on the needs of the user and the requirements of the web-based portal developer. The interactive electronic template is then automatically analyzed, along with the user provided-information, to obtain resulting user-tailored information. Finally, the user-tailored information is interactively rendered in a web browser at a remote site within the computer network, in response to automatically analyzing the interactive electronic template and the user-provided information. The user-provided business information is composed of business information. Those skilled in the art can appreciate that such information is not limited to only business information. Other types of information and data may also be utilized according to the method and system described herein (e.g., medical, scientific, engineering, educational, political, and so forth).

Product Configurator

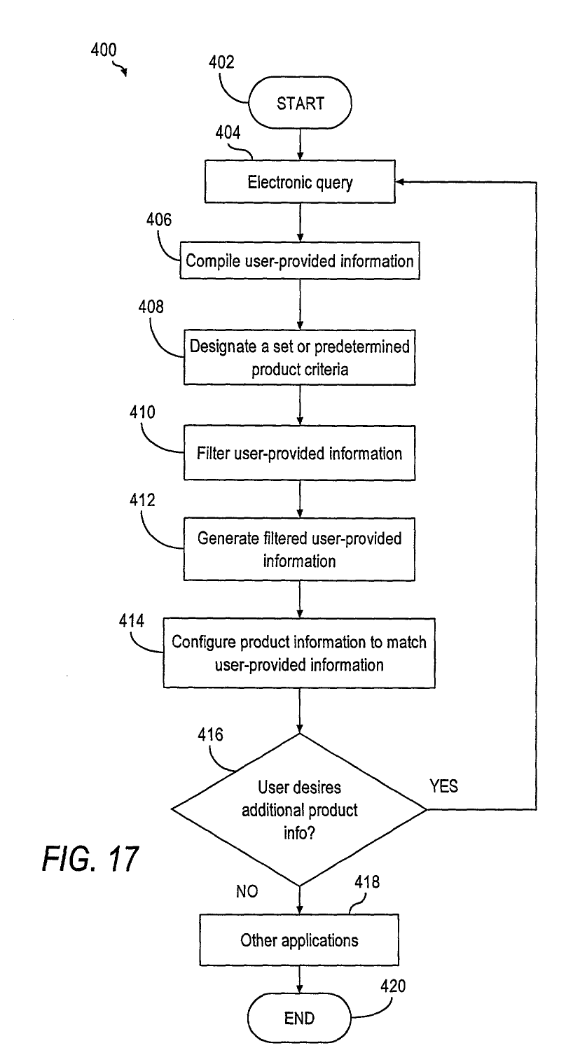

Based on the foregoing, those skilled in the art can appreciate that a unique aspect of the web-based portal described herein lies in the Product Configurator feature described herein, and referred to simply as a “Product Configurator” in accordance with the method and system of the present invention. The Product Configurator has been described with reference to FIG. 8 herein. A detailed explanation of method steps that may be implemented to practice the Product Configurator method and system described herein is found in FIG. 17. FIG. 17 illustrates a flow chart of operations 400 illustrating a lead generator method, in accordance with a preferred embodiment of the present invention.

Thus, process is initiated, as illustrated at block 402. The user is provided with an electronic query, as illustrated at block 404. The electronic query is displayed within a Web browser window. As explained previously, users answer specific questions related to particular business areas or lines of business. User-provided information is then compiled via the electronic query, as described at block 406. A set of predetermined product criteria is designated, either at this point or previously, based on particular product areas and services, as depicted at block 408. The user-provided information is filtered utilizing a set of predetermined product criteria associated with particular product information, as illustrated at block 410. Filtered user-provided information is then generated, as illustrated at block 412. This filtered user-provided information is associated with particular product information to enable the Product Configurator to match specific product information likely to be useful for the user or his company. The product information is thus configured to match the filtered user-provided information, as indicated at block 414, thereby enabling the web-based portal operator or developer to interactively identify and promote particular product information to the user based on the compiled user-provided information.

It must be determined, as illustrated at block 416, whether the user is interested in obtaining additional product information. The user is prompted to provide additional information via the electronic query, as indicated at block 404. This electronic query can be implemented in the form of a new electronic query with increasingly specific questions. Thereafter, particular product information can be configured to match newly filtered user-provided information compiled from the electronic query. Those skilled in the art can appreciate that the operation depicted at block 416 is analogous to the operation depicted at block 145 of FIG. 8. If additional information is not requested by the user, then other applications can be processed, as depicted at block 420. Such other applications include, for example, the Online Application or the Lead Generator described herein. Following processing of one or more of such applications, the process simply terminates, as illustrated at block 420.

FIG. 18 depicts a high-level block diagram illustrating a product configurator system, in accordance with a preferred embodiment of the present invention.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. The description as set forth herein is not intended to be exhaustive or to limit the invention to the precise form disclosed. For example, those skilled in the art can appreciate that the present invention can be utilize not only in the financial industries and arts, but a wide variety of other industries. Many modifications and variations are possible in light of the above teaching without departing from the spirit and scope of the following claims.

What is claimed is:

1. A method in a remote computer network for interactively identifying and promoting particular products via a web-based portal, wherein said remote computer network has at least one client connectable to one or more servers, said method comprising the steps of:
compiling user-provided information;
filtering said user-provided information utilizing a set of predetermined product criteria associated with particular product information; and
configuring said particular product information, such that said particular product information corresponds to filtered user-provided information, thereby enabling a web-based portal operator to interactively identify and promote said particular product information based on said compiled user-provided information.

2. The method of claim 1 wherein the step of compiling user-provided information, further comprises the step of:
compiling said user-provided information from an electronic query requiring user input.

3. The method of claim 2 further comprising the step of:
determining if a user associated with said user-provided information desires to obtain additional particular product information;
prompting said user to provide additional information via said electronic query, if it is determined that said user desires to obtain additional particular product information,; and
thereafter, configuring said particular product information to match newly filtered user-provided information compiled from said electronic query, in response to user input.

4. The method of claim 1 further comprising the step of:
generating a list of configured product information, in response to configuring said particular product information to match said filtered user-provided information; and
displaying said list of configured product information within said web-based portal.

5. The method of claim 4 further comprising the steps of:
prompting a user to select particular configured product information, in response to displaying said list of configured product information within said web-based portal; and
thereafter transmitting said particular configured product information to said user, in response to a user selection of said particular configured product information.

6. The method of claim 2 wherein the step of compiling said user-provided information from an electronic query requiring user input, further comprises the step of:
compiling said user-provided information from an electronic query requiring user input, said electronic query comprising an electronic template displayed within said web-based portal.

7. The method of claim 1 wherein the step of configuring said particular product information, such that said particular product information corresponds to filtered user-provided information, thereby enabling a web-based portal operator to interactively identify and promote said particular product information based on said compiled user-provided information, further comprises the step of:
automatically configuring said particular product information, such that said particular product information corresponds to filtered user-provided information, thereby enabling a web-based portal operator to interactively identify and promote said particular product information based on said compiled user-provided information.

8. The method of claim 1 wherein the step of configuring said particular product information, such that said particular product information corresponds to filtered user-provided information, thereby enabling a web-based portal operator to interactively identify and promote said particular product information based on said compiled user-provided information, further comprises the step of:
configuring said particular product information as appropriate for a user's business, based on said filtered user-provided information.

9. The method of claim 8 further comprising the step of:
permitting a sales representative to contact a user associated with said user-provided information, in response to configuring said particular product information to match said filtered user-provided information.

10. The method of claim 9 further comprising the step of:
designating a set of predetermined product criteria associated with particular product information.

11. A system in a remote computer network for interactively identifying and promoting particular products via a web-based portal, wherein said remote computer network has at least one client connectable to one or more servers, said system comprising:
compiling module for compiling user-provided information;
filtering module for filtering said user-provided information utilizing a set of predetermined product criteria associated with particular product information; and
configuring module for configuring said particular product information, such that said particular product information corresponds to filtered user-provided information, thereby enabling a web-based portal operator to interactively identify and promote said particular product information based on said compiled user-provided information.

12. The system of claim 11 further comprising:
compiling module for compiling said user-provided information from an electronic query requiring user input.

13. The system of claim 12 further comprising:
determining module for determining if a user associated with said user-provided information desires to obtain additional particular product information;
prompting module for prompting said user to provide additional information via said electronic query, if it is determined that said user desires to obtain additional particular product information,; and
configuring module for thereafter configuring said particular product information to match newly filtered user-provided information compiled from said electronic query, in response to user input.

14. The system of claim 11 further comprising:
generating module for generating a list of configured product information, in response to configuring said particular product information to match said filtered user-provided information; and
displaying module for displaying said list of configured product information within said web-based portal.

15. The system of claim 14 further comprising:
prompting module for prompting a user to select particular configured product information, in response to displaying said list of configured product information within said web-based portal; and
transmitting module for thereafter transmitting said particular configured product information to said user, in response to a user selection of said particular configured product information.

16. The system of claim 12 wherein further comprising:
compiling module for compiling said user-provided information from an electronic query requiring user input, said electronic query comprising an electronic template displayed within said web-based portal.

17. The system of claim 11 further comprising:
configuring module for automatically configuring said particular product information, such that said particular product information corresponds to filtered user-provided information, thereby enabling a web-based portal operator to interactively identify and promote said particular product information based on said compiled user-provided information.

18. A program product residing in computer memory in a remote computer network for interactively identifying and promoting particular products via a web-based portal, wherein said remote computer network has at least one client connectable to one or more servers, said program product comprising:
instruction module residing in a computer for compiling user-provided information;
instruction module residing in a computer for filtering said user-provided information utilizing a set of predetermined product criteria associated with particular product information; and
instruction module residing in a computer for configuring said particular product information, such that said particular product information corresponds to filtered user-provided information, thereby enabling a web-based portal operator to interactively identify and promote said particular product information based on said compiled user-provided information.

19. The program product of claim 18 further comprising:
instruction module residing in a computer for compiling said user-provided information from an electronic query requiring user input.

20. The program product of claim 19 further comprising:
instruction module residing in a computer for determining if a user associated with said user-provided information desires to obtain additional particular product information;
instruction module residing in a computer for prompting said user to provide additional information via said electronic query, if it is determined that said user desires to obtain additional particular product information,; and
instruction module residing in a computer for thereafter configuring said particular product information to match newly filtered user-provided information compiled from said electronic query, in response to user input.

21. The program product of claim 18 further comprising:
instruction module residing in a computer for generating a list of configured product information, in response to configuring said particular product information to match said filtered user-provided information; and
instruction module residing in a computer for displaying said list of configured product information within said web-based portal.

22. The program product of claim 21 further comprising:
instruction module residing in a computer for prompting a user to select particular configured product information, in response to displaying said list of configured product information within said web-based portal; and
instruction module residing in a computer for thereafter transmitting said particular configured product information to said user, in response to a user selection of said particular configured product information.

23. The program product of claim 19 wherein further comprising:
instruction module residing in a computer for compiling said user-provided information from an electronic query requiring user input, said electronic query comprising an electronic template displayed within said web-based portal.

24. The program product of claim 19 further comprising:
instruction module residing in a computer for automatically configuring said particular product information, such that said particular product information corresponds to filtered user-provided information, thereby enabling a web-based portal operator to interactively identify and promote said particular product information based on said compiled user-provided information.

25. The program product of claim 18 wherein each of said instructions module further comprise signal-bearing media.

26. The program product of claim 25 wherein said signal-bearing media comprises transmission media.

27. The program product of claim 25 wherein said signal-bearing media comprises recordable media.

28. A method in a remote computer network for interactively identifying and promoting particular products via a web-based portal, wherein said remote computer network has at least one client connectable to one or more servers, said method comprising the steps of:
compiling said user-provided information from an electronic query requiring user input;
filtering said user-provided information utilizing a set of predetermined product criteria associated with particular product information; and
configuring said particular product information, such that said particular product information corresponds to filtered user-provided information, thereby enabling a web-based portal operator to interactively identify and promote said particular product information based on said compiled user-provided information.
